(19) United States
(12) Patent Application Publication
(10) Pub. No.: US 2026/0011758 A1
(43) Pub. Date: Jan. 8, 2026

(54) SYSTEMS AND METHODS OF FAST START-UP AND WARM-UP IN TURBOCHARGED FUEL CELLS

(71) Applicant: Caterpillar Inc., Peoria, IL (US)

(72) Inventors: Sachin S. Deshmukh, Dunlap, IL (US); David Andrew Pierpont, Dunlap, IL (US)

(73) Assignee: Caterpillar Inc., Peoria, IL (US)

(21) Appl. No.: 18/761,536

(22) Filed: Jul. 2, 2024

(51) Int. Cl. H01M 8/04082; H01M 8/04007; H01M 8/04089; H01M 8/04225; H01M 8/04302; H01M 8/0432; H01M 8/04746

(52) U.S. Cl. CPC H01M 8/04216; H01M 8/04067; H01M 8/04089; H01M 8/04225; H01M 8/04302; H01M 8/04358; H01M 8/04753; H01M 2250/20

(57) ABSTRACT

Provided herein are systems and methods for improving warm-up times for fuel cells. A method of the present disclosure includes detecting, by one or more processors, a warm-up condition of a fuel cell, and controlling, by the one or more processors, a first valve and a second valve, to cause pressurized oxygen and pressurized hydrogen to be supplied to a catalytic converter arranged downstream from the fuel cell, to cause the catalytic converter to produce heat to be transferred to a coolant loop of the fuel cell, during the warm-up condition.

### TECHNICAL FIELD

The present implementations relate generally to fuel cells and more particularly to systems and methods of enhancing start-up and warm-up strategies in a turbocharged fuel cell system.

### BACKGROUND

The present disclosure relates generally to fuel cell systems, and more particularly to fast start-up and warm-up strategies for turbocharged fuel cell systems. In some implementations, fuel cells may need to reach a minimum temperature to start producing power and/or to reach full power capability. This start-up and warm-up time may significantly vary in range. Therefore, it may be beneficial to decrease start-up and warm-up times.

For example, U.S. Pat. No. 8,617,752 describes a fuel cell system that is heated by a fluid during a starting operation to mitigate against vapor condensation and ice formation in a fuel cell assembly and to decrease a warm up time of the fuel cell system.

### SUMMARY

A first aspect provided herein relates to a vehicle. The vehicle may include a storage configured to store pressurized hydrogen; a compressor configured to pressurize oxygen from air received at an intake of the compressor; a fuel cell comprising an anode loop fluidically coupled to the storage and configured to receive the pressurized hydrogen therefrom and a cathode loop configured to receive the pressurized oxygen; a catalytic converter arranged downstream from the anode loop, the catalytic converter configured to receive the pressurized hydrogen from the storage and receive at least one of recovered oxygen from the oxygen used by the cathode loop or pressurized oxygen from the compressor; a first valve arranged downstream from the storage, the first valve configured to control a flow of the pressurized hydrogen from the storage to the anode loop or to the catalytic converter; a second valve fluidically coupled to the compressor, the second valve configured to control a flow of the pressurized oxygen from the compressor to the cathode loop or to the catalytic converter; and a processing circuit comprising one or more processors and memory, the memory storing instructions that, when executed, cause the processing circuit to: detect a warm-up condition of the fuel cell; and control the first and the second valve, to cause the pressurized oxygen and the pressurized hydrogen to be supplied to the catalytic converter, to cause the catalytic converter to produce heat to be transferred to a coolant loop of the fuel cell, during the warm-up condition.

A second aspect provided herein relates to an energy system. The energy system may include a storage configured to store pressurized hydrogen; a compressor configured to pressurize oxygen from air received at an intake of the compressor; a fuel cell comprising an anode loop fluidically coupled to the storage and configured to receive the pressurized hydrogen therefrom and a cathode loop configured to receive the pressurized oxygen; a catalytic converter arranged downstream from the anode loop, the catalytic converter configured to receive the pressurized hydrogen from the storage and receive at least one of recovered oxygen from the oxygen used by the cathode loop or pressurized oxygen from the compressor; a first valve arranged downstream from the storage, the first valve configured to control a flow of the pressurized hydrogen from the storage to the anode loop or to the catalytic converter; a second valve fluidically coupled to the compressor, the second valve configured to control a flow of the pressurized oxygen from the compressor to the cathode loop or to the catalytic converter; and a processing circuit comprising one or more processors and memory, the memory storing instructions that, when executed, cause the processing circuit to: detect a warm-up condition of the fuel cell; and control the first and the second valve, to cause the pressurized oxygen and the pressurized hydrogen to be supplied to the catalytic converter, to cause the catalytic converter to produce heat to be transferred to a coolant loop of the fuel cell, during the warm-up condition.

A third aspect provided herein relates to a method. The method may include detecting, by one or more processors, a warm-up condition of a fuel cell, wherein the fuel cell comprises an anode loop and a cathode loop; and controlling, by the one or more processors, a first valve and a second valve, to cause pressurized oxygen and pressurized hydrogen to be supplied to a catalytic converter arranged downstream from the fuel cell, to cause the catalytic converter to produce heat to be transferred to a coolant loop of the fuel cell, during the warm-up condition. The first valve may be configured to control a flow of the pressurized hydrogen from a hydrogen source to the anode loop or to the catalytic converter; and the second valve may be configured to control a flow of the pressurized oxygen from a compressor to the cathode loop or the catalytic converter.

### BRIEF DESCRIPTION OF THE DRAWINGS

These and other aspects and features of the present implementations will become apparent to those ordinarily skilled in the art upon review of the following description of specific implementations in conjunction with the accompanying figures.

FIG. 1 is a block diagram of a system for improving warm-up and start-up times of fuel cells, in accordance with present implementations;

FIG. 2 is a schematic diagram of anode and cathode loops of a fuel cell system, in accordance with present implementations;

FIG. 3 is a schematic diagram of coolant and high voltage loops of a fuel cell system, in accordance with present implementations;

FIG. 4 is a schematic diagram of anode and cathode loops of a fuel cell system, in accordance with present implementations;

FIG. 5 is a schematic diagram of coolant and high voltage loops of a fuel cell system, in accordance with present implementations;

FIGS. 6A-6C are schematic diagrams of anode and cathode loops of a fuel cell system, in accordance with present implementations;

FIG. 7 is a schematic diagram of coolant and high voltage loops of a fuel cell system, in accordance with present implementations;

FIG. 8 is a flowchart showing a method of improving warm-up and start-up times of fuel cells, in accordance with present implementations.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Referring generally to the FIGURES, systems and methods described herein may be configured, designed, or otherwise arranged to decrease start-up and/or warm-up times of fuel cells. Specifically, a system may include a storage source configured to store pressurized hydrogen and a compressor configured to pressurize oxygen from air. The system may include at least one fuel cell having an anode loop configured to receive the pressurized hydrogen from the storage and a cathode loop configured to receive the pressurized oxygen from the compressor. The system may include a catalytic converter disposed downstream from the anode loop, the cathode loop, the hydrogen storage source, and/or the compressor. The catalytic converter may be fed pressurized hydrogen from the storage source and/or diluted recovered hydrogen not used by the anode loop. For example, the system may include at least one valve configured to control a flow of the pressurized hydrogen between the anode loop and the catalytic converter. The catalytic converter may be fed pressurized oxygen from the compressor and/or recovered oxygen not used by the cathode loop. For example, the system may include at least one valve configured to control a flow of the pressurized oxygen between the cathode loop and the catalytic converter.

The system may control the valves to direct the flow of pressurized hydrogen and/or oxygen based on a warm-up condition of the system. For example, one or more sensors may be configured to detect a warm-up or start-up condition of the system and, responsive to detecting the warm-up or start-up condition, cause pressurized hydrogen from the storage source and pressurized oxygen from the compressor to be fed to the catalytic converter (e.g., bypass or at least partially bypass the anode and/or cathode loops) to quickly increase a temperature of exhaust gases out of the catalytic converter. The high-temperature exhaust gas from the catalytic converter may be fed through a heat exchanger to transfer heat from the catalytic converter to a coolant loop of the system, to increase a temperature of the coolant loop, and thus decrease the warm-up time for the system. For example, feeding pressurized hydrogen and oxygen to the catalytic converter, which may be battery-powered, may allow the system to quickly reach a minimum temperature in which the fuel cells can produce power (e.g., maximum power).

When the system determines the warm-up condition is terminated (e.g., based on a temperature of the coolant reaching a threshold), the system may cause the valves to feed the pressurized hydrogen and oxygen through the anode and cathode loops (e.g., bypassing or at least partially bypassing the hydrogen and oxygen pathways directly to the catalytic converter). The catalytic converter may be fed any excess hydrogen and oxygen from the anode and cathode loops and increase an exhaust temperature. The warm exhaust gases may be fed through the heat exchanger to continue heating the coolant and/or the warm exhaust gases may be fed to an expander to recover the heat, thus increasing the efficiency of the system.

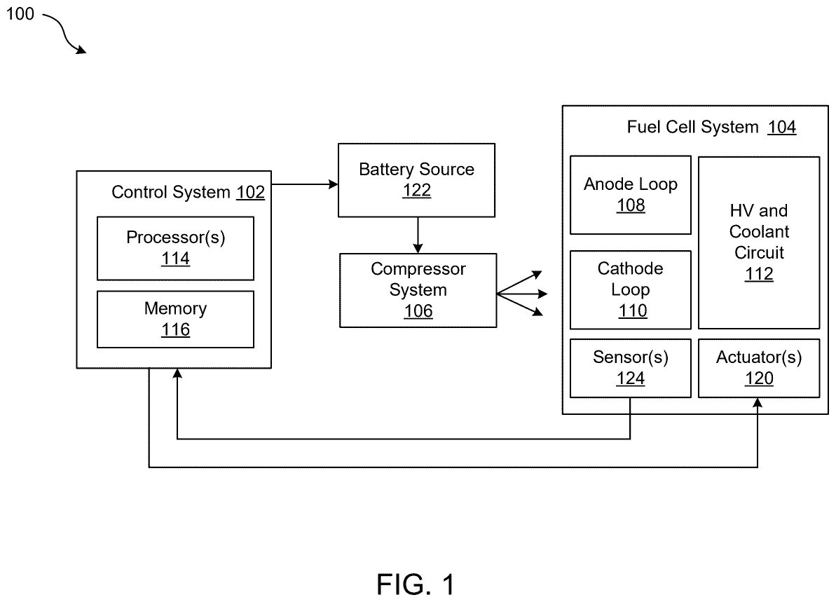

Referring now to FIG. 1, depicted is a block diagram of a system 100 for improving start-up and/or warm-up times for fuel cells, according to an example implementation of the present disclosure. The system 100 may include a control system 102 communicably coupled to a fuel cell system 104 and a compressor system 106. The system 100 may be implemented in various environments or systems. For example, the system 100 may be implemented in various vehicles for supplying power to the vehicle, as a power generation system for homes or businesses (e.g., primary or back-up power), etc. In some embodiments, the system 100 may be implemented in various heavy machinery components or vehicles to supply power thereto. As described in greater detail herein, the control system 102 may be configured to control the fuel cell system 104 and the compressor system 106 to increase a temperature of at least a portion of the fuel cell system 104 to improve start-up and/or warm-up times of the system 100. For example, the system 100 may be configured to detect a warm-up and/or start-up condition of a fuel cell and cause one or more valves to supply pressurized hydrogen and pressurized oxygen to a catalytic converter to cause the catalytic converter to produce heat to be transferred to a coolant loop responsive to detecting a warm-up or start-up condition. The transferred heat may facilitate increasing a temperature of the system 100 to improve the start-up and/or warm-up time.

The fuel cell system 104 may include various types or forms of fuel cells. In some embodiments, the fuel cell system 104 may be or include a proton exchange membrane (PEM) fuel cell. For example, the fuel cell system 104 may be or include a high temperature PEM (HT-PEM) fuel cell (e.g., a fuel cell which operates at high temperatures at fully warm conditions, such as 160° C. to 200° C.) or a low temperature PEM (LT-PEM) fuel cell (e.g., a fuel cell which operates at low temperatures [relative to HT-PEM fuel cells] at fully warm conditions, such as 70° C.). In various embodiments, the fuel cell system 104 may include other types of fuel cells, such as solid oxide fuel cells (SOFCs), molten carbonate fuel cells (MCFCs), alkaline fuel cells (AFCs), phosphoric acid fuel cells (PAFCs), and/or direct methanol fuel cells (DMFCs).

The fuel cell system 104 may include an anode loop 108, a cathode loop 110, and a high voltage (HV) and coolant circuit 112. As described in greater detail herein, the anode loop 108 may be configured to be supplied with hydrogen. The cathode loop 110 may be configured to be supplied with oxygen. The anode loop 108 and cathode loop 110 may supply the hydrogen and oxygen to a PEM, which converts the hydrogen into protons and electrons, the protons interacting with the oxygen for producing heat and water, and the electrons supplied as power.

The control system 102 may include one or more processors 114 and memory 116. The processor(s) 114 may be or include any device, component, element, or hardware designed or configured to perform the various steps recited herein. For example, the processor(s) 114 may include any number of general purpose single- or multi-chip processors, digital signal processors (DSP), application specific integrated circuits (ASIC), field programmable gate arrays (FPGA), or other programmable logic device(s), discrete gate or transistor logic, discrete hardware components, or any combination thereof designed or configured to perform the various steps recited herein. In some embodiments, the control system 102 may include a single processor 114 designed or configured to perform each of the various steps recited herein. In some embodiments, the control system 102 may include multiple processors 114 which are designed or configured perform (e.g., either separately or together) each of the various steps recited herein. As one example, the control system 102 may include a first processor 114 designed or configured to perform a first subset of the various steps, and a second processor 114 designed or configured to perform a second subset of the various steps (with the first subset being different from the second subset). As another example, the control system 102 may include first and second processors 114 which together perform the various steps in a distributed fashion. As such, unless explicitly indicated otherwise, such as by use of a term such as “a single processor,” the term “one or more processor(s)” as used herein contemplates and encompasses embodiments in which all of the one or more processors perform all of the recited steps or features, different processors separately perform different ones of the steps or features, the same or different sets of two or more processors work in combination to perform individual steps or features, or any variation thereof. In other words, unless explicitly indicated otherwise, the use of the term “one or more processors” herein contemplates and encompasses a single processor performing all of the recites steps or features and two or more processors working individually or in combination, where each step or feature is performed by any one or combination of two or more of the processors. The memory 116 may be or include any type or form of data storage device, including tangible, non-transient volatile memory and/or non-volatile memory.

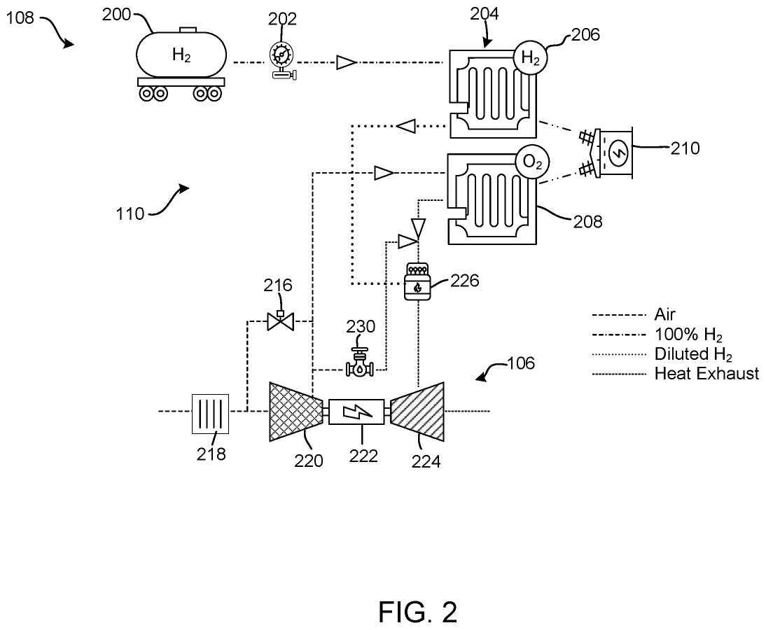

Referring now to FIG. 1 and FIG. 2, the fuel cell system 104 may include the anode loop 108 and the cathode loop 110. Specifically, FIG. 2 is a schematic diagram of the anode and cathode loops 108, 110 of the fuel cell system 104, according to an implementation of the present disclosure. As shown in FIG. 2, the anode loop 108 may include a hydrogen storage source 200 configured to store and/or provide hydrogen. The hydrogen source 200 may be fluidically coupled to the anode loop 108. The hydrogen storage source 200 may be communicably and/or fluidically coupled to a pressure regulator 202. The pressure regulator 202 may be disposed between the hydrogen source 200 and the anode loop 108. The hydrogen source 200 may be configured to supply or otherwise provide hydrogen (e.g., H₂) to the pressure regulator 202. The pressure regulator 202 may be configured to increase, decrease, or otherwise regulate the supplied hydrogen from the hydrogen source 200 for supplying hydrogen to a proton exchange membrane (PEM) 204. The hydrogen source 200 may be configured to store pressurized hydrogen and/or the pressure regulator 202 may be configured to pressurize the hydrogen from the hydrogen source 200 to provide pressurized hydrogen to the PEM 204. Specifically, the pressure regulator 202 may be configured to supply the pressurized hydrogen to the anode loop 108 (e.g., to an anode catalyst 206 of the PEM 204). In some implementations, the hydrogen source 200 may additionally be fluidically coupled to a catalytic converter to provide pressurized hydrogen to the catalytic converter, as described herein.

The cathode loop 110 may have air (e.g., ambient air) supplied thereto. Specifically, oxygen (e.g., pressurized oxygen) from the ambient air may be supplied to a cathode catalyst 208 of the PEM 204. The cathode loop 110 may include an air filter 218 arranged at an inlet to the cathode loop 110, to filter air prior to entering the cathode loop 110. For example, in some implementations, the ambient air may be fed through the filter 218 and/or a compressor 220 prior to being supplied to the cathode catalyst 208 to filter the air and increase the pressure and/or temperature of the air prior to the cathode loop 110. Together, the hydrogen supplied to the anode catalyst 206 and the oxygen supplied to the cathode catalyst 208 may operate to produce electrical energy and heat for the fuel cell. More specifically, the hydrogen may be split into protons and electrons at the anode catalyst 206, and the oxygen may combine with the protons and electrons to produce electricity and water, with heat generated as a byproduct. The electrons may flow to an electrical power circuit 210 (e.g., a high-voltage bus) to generate electrical power, while the protons may move through the PEM 204 to facilitate the electrochemical reactions for producing the water and heat.

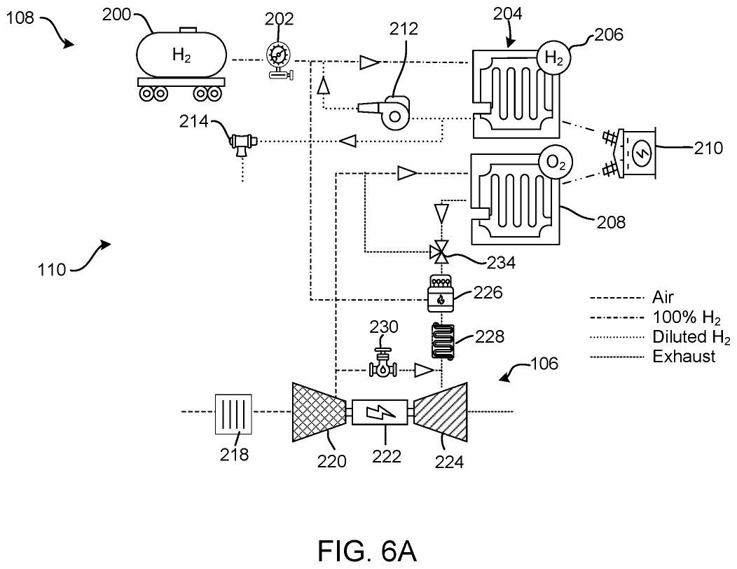

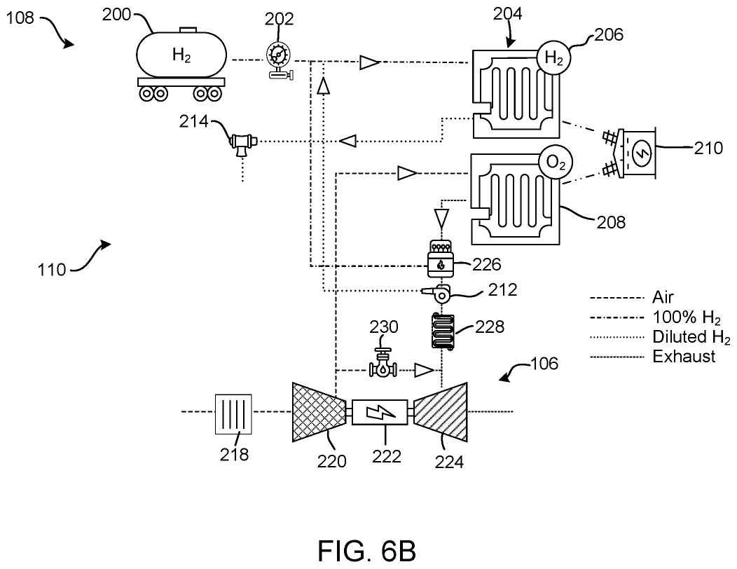

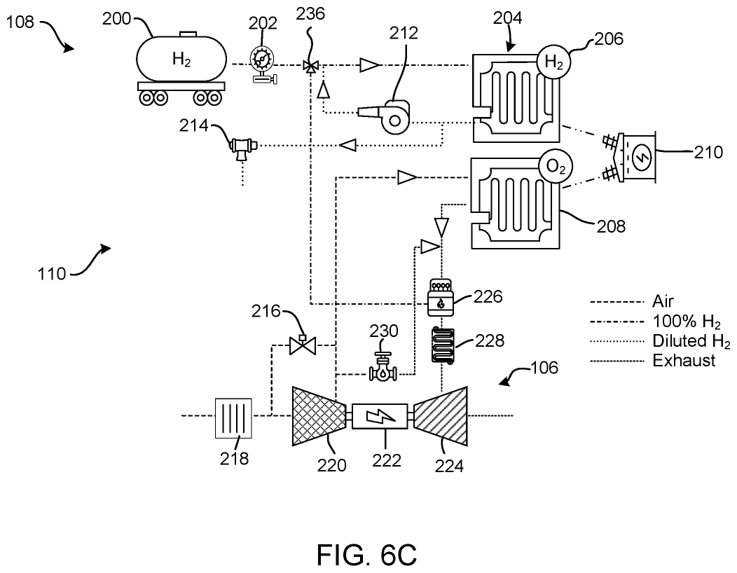

The fuel cell system 104 may include a catalytic converter 226 communicably coupled to one or more components including, but not limited to, the hydrogen source 200, the compressor 220, the anode catalyst 206, and/or the cathode catalyst 208. In some implementations, the catalytic converter 226 may be arranged downstream from the hydrogen source 200, the compressor 220, the anode loop 108, and/or the cathode loop 110. In some implementations, the catalytic converter 226 may be configured to receive pressurized hydrogen from the hydrogen storage 200 and/or the pressure regulator 202. Specifically, the catalytic converter 226 may be fed pure pressurized hydrogen from the hydrogen source 200. In some implementations, the catalytic converter 226 may be additionally or alternatively configured to at least partially recover excess hydrogen from the pressurized hydrogen used by the anode loop 108. Specifically, the catalytic converter 226 may be fed diluted excess hydrogen not used in the anode loop 108 by the anode catalyst 206. For example, as depicted in FIG. 6C, the fuel cell system 104 may include at least one flow control valve 236 arranged downstream from the hydrogen storage 200 and/or pressure regulator 202. The flow control valve 236 may be configured to selectively control a flow of pressurized hydrogen from the hydrogen source 200 to the anode loop 108 (e.g., the anode catalyst 206) and/or to the catalytic converter 226 (e.g., via the control system 102 responsive to detecting a warm-up or start-up condition). For example, the flow control valve 236 may be configured to fluidically couple the hydrogen storage 200 to at least one of a first path to the anode loop 108 or a second path to the catalytic converter 226. In other words, the catalytic converter 226 may be configured to receive pure hydrogen from the hydrogen source 200 and/or diluted or recovered hydrogen from the anode loop 108 based on the flow control valve 236 and/or responsive to one or more conditions of the fuel cell system 104.

In some implementations, the catalytic converter 226 may be communicably coupled to the compressor 220 to receive pressurized oxygen from the compressor 220. In some implementations, the catalytic converter 226 may additionally or alternatively be configured to at least partially recover excess oxygen in the form of heat exhaust (e.g., warm air or steam) from the oxygen used by the cathode loop 110. In other words, the catalytic converter 226 may be fed oxygen not used in the cathode loop 110 by the cathode catalyst 208. For example, the fuel cell system 104 may include at least one bypass valve 230 fluidly coupled to the compressor 220 and configured to control a flow of pressurized oxygen from the compressor 220 to the cathode loop 110 (e.g., the cathode catalyst 208) and/or to the catalytic converter 226 (e.g., via the control system 102 responsive to detecting a warm-up or start-up condition), as depicted in FIG. 6C. For example, the bypass valve 230 may be configured to fluidically couple the compressor 220 to at least one of a first path to the cathode loop 110 or a second path to the catalytic converter 226. In other words, the catalytic converter 226 may be configured to receive pressurized oxygen from the compressor 220 and/or excess or recovered oxygen not used by the cathode loop 110 based on the bypass valve 230 and/or responsive to one or more conditions of the fuel cell system 104. In some implementations, the bypass valve 230 may be arranged downstream from the compressor 220 to selectively supply pressurized oxygen from the compressor 220 to the catalytic converter 226. Such implementation may facilitate managing surge and hydrogen catalyst to control the air-fuel ratio in the catalytic converter 226.

In some implementations, the catalytic converter 226 may be battery powered. For example, the catalytic converter 226 may include a battery powered heated hydrogen catalyst converter. With this configuration, the catalytic converter 226 may be configured to operate even when the PEM 204 is not at a temperature to sustain a maximum power output. In some implementations, for example, the battery source 122 and/or another battery may be configured to operate the catalytic converter 226.

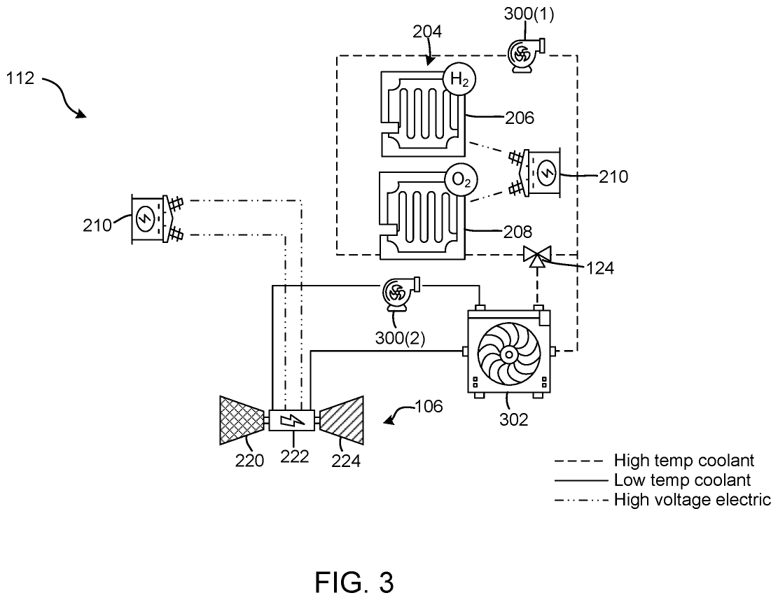

Referring now to FIG. 1 and FIG. 3, the fuel cell system 104 may include the HV and coolant circuit 112. More specifically, FIG. 3 is a schematic diagram of the HV and coolant circuits 112 of the fuel cell system 104, according to an embodiment of the present disclosure. The coolant circuit 112 may include various pumps 300 for pumping coolant through the coolant circuit 112. For example, a first pump 300(1) may pump high temperature coolant through the PEM 204, and a second pump 300(2) may pump low temperature coolant from the compressor 220 and/or compressor system 106 through the coolant circuit 112. The coolant circuit 112 may include a heat exchanger 302. The heat exchanger 302 may be configured to transfer absorbed heat from the coolant to an external fluid (e.g., air or some other cooling medium) to dissipate heat, and/or preheat incoming coolant. The coolant circuit 112 may include one or more sensor(s) 124 arranged to measure, detect, or otherwise quantify a temperature of coolant of the coolant circuit 112. In some embodiments, the sensor(s) 124 may be or include temperature sensors arranged to measure the temperature of the coolant. For example, the sensor(s) 124 may be a thermostat, which may include a valve for controlling the flow of coolant to the heat exchanger 302.

As shown in FIG. 2 and FIG. 3, the compressor 220 may be arranged to supply compressed (and thus heated) air to the coolant circuit 112. Specifically, as shown in FIG. 2, the compressor 220 may supply compressed and heated air to the cathode catalyst 208 of the PEM 204 (e.g., the air side of the stack of the PEM 204), and as shown in FIG. 3, the coolant may pump through the cathode catalyst 208.

In some implementations, the control system 102 or another component of the system 100 may be configured to detect a warm-up or start-up condition of the fuel cell system 104. For example, one or more sensors communicably coupled to the control system 102 may be configured to detect a temperature or other condition of a component of the vehicle and determine, based on the condition, that the fuel cell system 104 is undergoing a start-up and warm-up condition. For example, the control system 102 may be configured to detect, determine, or otherwise identify a warm-up condition of the fuel cell system 104. In some embodiments, the control system 102 may be configured to identify the warm-up condition of the fuel cell system 104 based on data from a timer. For example, the control system 102 may measure a duration or time from a previous run-time of the fuel cell system 104. The control system 102 may identify the warm-up condition responsive to the measured duration satisfying a threshold (e.g., being greater than or equal to a duration corresponding to the warm-up condition). The threshold may be set based on the particular fuel cell system 104, an estimated time in which heat of the fuel cell system 104 naturally dissipates, etc. In some embodiments, the control system 102 may be configured to identify the warm-up condition of the fuel cell system 104 based on data from a sensor 124. For example, the control system 102 may be configured to identify the warm-up condition of the fuel cell system 104 responsive to a temperature of coolant of the HV and coolant circuit 112 satisfying or being below a threshold (e.g., being less than or equal to a threshold temperature of coolant for operating the fuel cell system 104 for producing power).

In some implementations, the control system 102 may be configured to activate the compressor system 106 to supply compressed heated air to the catalytic converter 226 during the warm-up condition. For example, the control system 102 may be configured to activate the compressor system 106 responsive to identifying the warm-up condition. In some implementations, responsive to determining the warm-up or start-up condition, the control system 102 may be configured to cause the catalytic converter 226 to receive pressurized hydrogen and pressurized oxygen. For example, the control system 102 may be configured to cause the flow control valve 236 to cause a flow of pressurized pure hydrogen to the catalytic converter 226 and cause the bypass valve 230 to cause a flow of pressurized oxygen to the catalytic converter 226. The catalytic converter 226 may be configured to increase the temperature of the oxygen and hydrogen through the catalytic converter 226. For example, the catalytic converter 226 may produce heat in the form of output exhaust gas.

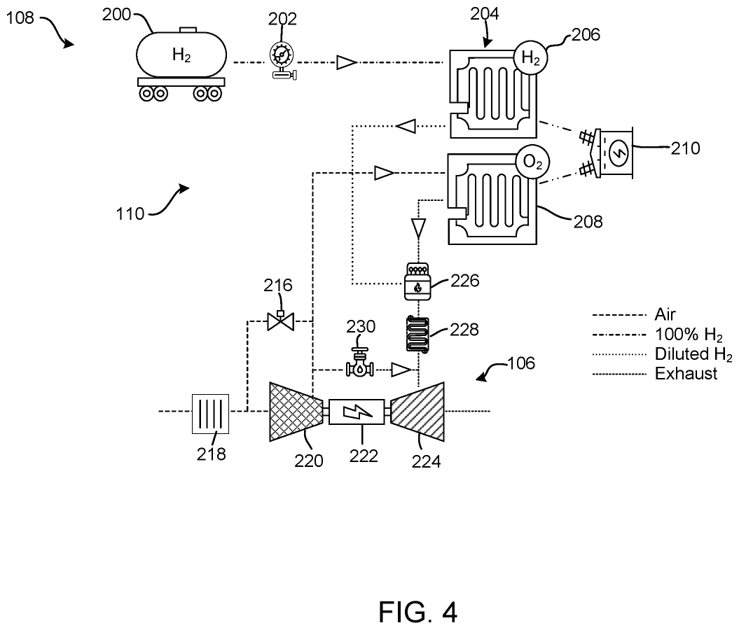

The compressor 220 may be powered by a battery during the warm-up condition. For example, in some embodiments, the control system 102 may activate the compressor system 106 and/or the catalytic converter 226 by sending a signal to the battery source 122 to supply power to the compressor system 106 and/or the catalytic converter 226. In some embodiments, the control system 102 may activate the compressor system 106 to run at a high speed and high pressure ratio to compress and heat air supplied to the catalytic converter 226. The compressor 220 may be configured to heat the air to high temperature (up to 200° C.) at, e.g., maximum compressor system 106 speed (when the turbocharger 222 and battery source 122 are driving the compressor system 106 at maximum speed or output). The compressor 220 may be arranged or configured to supply the high pressure and temperature air through the catalytic converter 226 to warm up the exhaust gases through the catalytic converter 226 and the coolant circuit 112. The compressor 220 may be arranged to supply the high pressure and temperature air through the catalytic converter 226 and transfer heat from the catalytic converter to the coolant circuit 112. In some implementations, the catalytic converter 226 may be configured to supply heat to the coolant circuit 112 through a heat exchanger. For example, in some implementations, the fuel cell system 104 may include a heat exchanger 228 as shown in FIGS. 4-7. Specifically, the heat exchanger 228 may be arranged downstream of the catalytic converter 226.

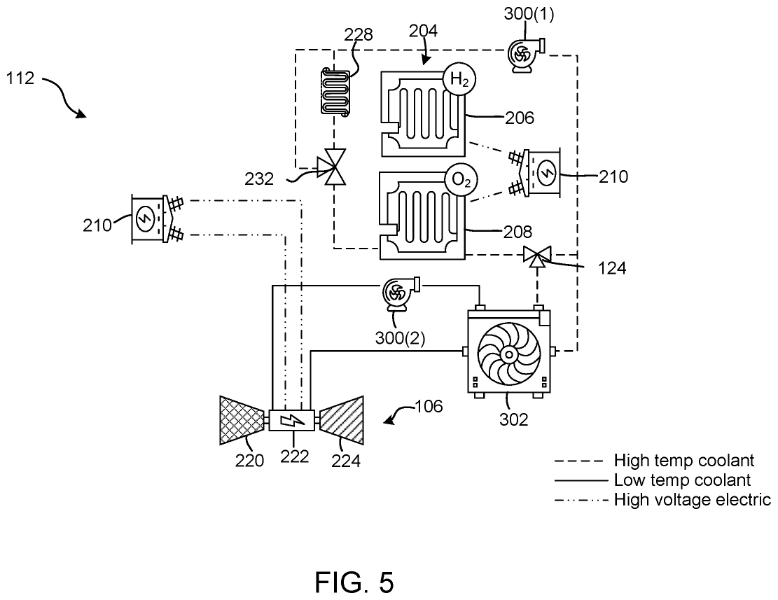

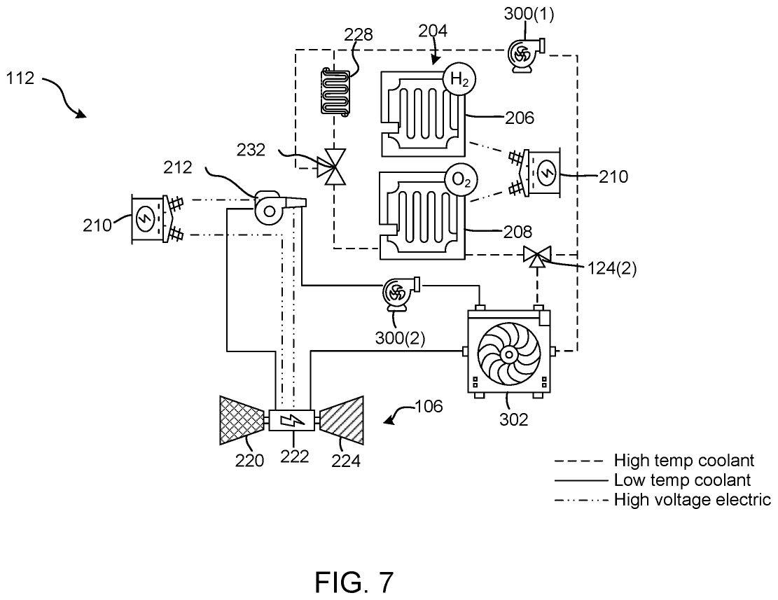

The heat exchanger 228 may be configured to facilitate fast warm-up by transferring heat outputted from the catalytic converter 226 to the coolant of the coolant circuit 112, as depicted in FIGS. 5 and 7. For example, the heat exchanger 228 may be configured to facilitate heat transfer from gases downstream of the catalytic converter 226 to the coolant of the coolant circuit 112 to raise the coolant or other portion of the system 100 to a substantially normal or desired operating temperature (e.g., 160-200° C.). The coolant circuit 112 may include at least one bypass valve 232 (e.g., a heat exchanger bypass valve 232). The bypass valve 232 may be configured to selectively cause the coolant flow through the coolant circuit 112 to flow through the heat exchanger 228 or bypass the heat exchanger 228. In other words, the bypass valve 232 may be configured to control coolant temperature by bypassing a portion of the coolant through a bypass loop. For example, in some implementations, the control system 102 may be configured to activate the bypass valve 232 based on, for example, a temperature reading of the coolant by a sensor 124. In some implementations, excess heat exhaust from the heat exchanger 228 may be configured to be fed to the expander 224 to increase efficiency. In some implementations, the coolant circuit 112 may include a recirculation blower 212, as depicted in FIG. 7.

The control system 102 may be configured to cause the catalytic converter 226 to receive pressurized hydrogen from the hydrogen source 200 and pressurized oxygen from the compressor 220 until the coolant of the coolant circuit 112 satisfies a threshold criteria. For example, the control system 102 may detect, via a sensor 124, a temperature condition of a coolant and determine that the warm-up is complete or a termination of the warm-up condition (e.g., that the temperature of the coolant circuit 112 is at a desired operating temperate). When the control system 102 determines the fuel cell system 104 is not under a warm-up or start-up condition, the control system 102 may be configured to cause the flow control valve 236 to cause a flow of hydrogen to be fed through the anode loop 108 and the bypass valve 230 to cause a flow of oxygen to be fed through the cathode loop 110. The control system 102 may be configured to detect a termination of the warm-up condition based on, for example, a sensor (e.g., sensor 124) arranged to measure a temperature of the coolant circuit 112.

The catalytic converter 226 may be configured to recover excess hydrogen and oxygen from the anode loop 108 and cathode loop 110 to increase the efficiency of the fuel cell system 104. For example, the temperature of the excess oxygen out of the cathode loop 110 may be between 160° C. to 200° C. The excess hydrogen from the anode loop 108 may be configured to combine with the excess oxygen from the cathode loop 110 and routed through the catalytic converter 226 to release hydrogen energy and increase the heat exhaust temperature through the fuel cell system 104. For example, in some implementations, the temperature of the excess heat exhaust (e.g., warm air or steam) out of the catalytic converter 226 may be between 200° C. to 300° C. The high-pressure and high-temperature heat exhaust from the catalytic converter 226 may then be fed to an expander 224 of the compressor system 106 to extract, for example, work from the heat exhaust.

For example, in various embodiments, the compressor system 106 may be or include a turbo compressor system 106. The compressor system 106 may be communicably coupled to the control system 102 and powered by a battery source 122. In this regard, the compressor system 106 may be or include an eTurbo (e.g., an electric turbo) compressor system 106. The battery source 122 may be an external battery source separate from the electrical power circuit 210. In some embodiments, the battery source 122 may be charged by or using electrical power of the electrical power circuit 210. As shown in FIG. 2, the compressor system 106 may include the compressor 220, a turbocharger 222, and an expander 224. The compressor 220 may receive air as an input (e.g., downstream from the filter 218), and compress the air received at an intake of the compressor 220 to supply pressurized, and correspondingly heated, air to the cathode catalyst 208 and/or to another portion of the fuel cell system 104 (e.g., the catalytic converter 226 as described herein).

The turbocharger 222 may be configured to use or leverage energy from the flow of exhaust gases (e.g., the heat exhaust described herein) from the system 100 to drive the compressor 220 (e.g., alone or together with the battery source 122). For example, the expander 224 may be configured to recover some of the energy from the pressurized heat exhaust. Specifically, the expander 224 may be communicably coupled to the catalytic converter 226 and may be configured to recover the heat exhaust supplied from the catalytic converter 226. For example, as described herein, the catalytic converter 226 is configured to increase the temperature of heat exhaust to increase the amount of heat recoverable by the expander 224. In other words, the catalytic converter 226 may be configured to supply re-heated heat exhaust (e.g., air or steam) to the expander 224 to extract mechanical energy to at least partially operate, for example, the compressor 220, or for another application. Such implementation allows for the fuel cell system 104 to operate with a maximum efficiency as compared to conventional techniques while minimizing manufacturing efforts and costs for the system 100.

The fuel cell system 104 may include various actuators 120. The actuators 120 may include pumps, valves, regulators, diverters, or any other actuators designed or configured to control the flow of a fluid. For instance, the cathode loop 110 may include various actuators 120 for regulating the flow of air to or from the cathode catalyst 208. For example, the cathode loop 110 may include at least one recirculation valve 216 for selectively recirculating air back to the compressor 220. As shown in FIG. 2, and in some embodiments, the cathode loop 110 may include a recirculation valve 216 arranged downstream of the compressor to supply heated air (e.g., pressurized oxygen) from the compressor 220 (e.g., output by the compressor 220) back to an input of the compressor 220. In such an example, at least a portion of the heated air may be heated twice, then re-output by the compressor 220 towards the cathode catalyst 208 and/or catalytic converter 226, thereby increasing the temperature and/or pressure of the fuel cell system 104 faster.

Similarly, the anode loop 108 may include various actuators 120 for controlling the flow of hydrogen to the anode catalyst 206 and/or catalytic converter 226. For example, the cathode loop 110 may include the pressure regulator 202. Additionally, the HV and coolant circuit 112 may include various actuators 120 for controlling the flow of coolant. For example, the HV and coolant circuit 112 may include various pumps 300 and a sensor (e.g., a thermostat) 124 with an included actuator for controlling the flow of coolant through the coolant circuit 112.

In some implementations, the fuel cell system 104 may include at least one a hydrogen recirculation blower 212. As depicted in FIG. 6A, the hydrogen recirculation blower 212 may be arranged downstream of the anode catalyst 206 to recover excess hydrogen (e.g., diluted hydrogen) not used by the anode catalyst 206. The hydrogen recirculation blower 212 may be configured to pump the excess hydrogen back into the input of the anode catalyst 206 to increase the efficiency of the anode loop 108. As depicted in FIG. 6B, a hydrogen recirculation blower 212 may optionally be provided and arranged downstream from the catalytic converter 226 and/or upstream of the heat exchanger 228. The hydrogen recirculation blower 212 may be configured to supply at least some of any excess hydrogen used by the catalytic converter 226 to the anode loop 108. For example, the hydrogen recirculation blower 212 may be configured to pump excess hydrogen from the catalytic converter 226 back into the input of the anode catalyst 206 to increase the efficiency of the anode loop 108.

In some implementations, the fuel cell system 104 may include at least one flow control valve 234, as depicted in FIG. 6A. The flow control valve 234 may be configured to selectively cause recovered oxygen from the cathode loop 110 to flow through the catalytic converter 226 or to supply the recovered oxygen back to the cathode loop 110 as an input to the cathode catalyst 208 to regulate the recovered oxygen from the cathode loop 110. For example, in some implementations, the control system 102 may be configured to activate the flow control valve 234 based on, for example, a sensor reading of an amount of hydrogen or oxygen being fed to the catalytic converter 226 and/or a sensor reading of an amount of oxygen being fed to the cathode catalyst 208.

In some implementations, the fuel cell system 104 may include at least one purge valve 214. The purge valve 214 may be fluidically coupled to and arranged downstream of the anode catalyst 206. The purge valve 214 may be configured to modify the pressure of the excess hydrogen from the anode loop 108 and/or remove excess hydrogen from the anode loop 108. For example, the purge valve 214 may open and close, to throttle the diluted hydrogen flow to maintain stable pressure within the anode loop 108 (e.g., by ensuring that the pressure is neither too high, which can cause mechanical stress, nor too low, which can reduce efficiency of the system).

In some implementations, as depicted in FIGS. 4 and 6A-6B, the compressor bypass valve 230 may be additionally or alternatively configured to divert air that may be fed from the compressor 220 to the cathode catalyst 208 to instead be fed into the expander 224. For example, the bypass valve 230 may be configured to selectively supply pressurized oxygen from the compressor 220 to the expander 224 to provide heated air to the expander 224.

### INDUSTRIAL APPLICABILITY

The disclosed embodiments may be applicable to any fuel cell-based system or solution. For example, the disclosed embodiments may be applicable to or applied to a vehicle, such as an automobile, heavy machinery, or any other type of vehicle, a power source for a home, office, or any other residential/industrial setting, or any other power delivery system which may be powered by a fuel cell. The disclosed embodiments may be applicable to fuel cell-based systems which use or include HT-PEM fuel cells, or fuel cells which are designed to operate at high temperatures.

The disclosed embodiments may be used to improve start-up and warm-up times of the system 100 by providing pressurized hydrogen and pressurized oxygen to a hydrogen catalytic converter 226, resulting in increased exhaust gas temperature that can supply heat to a coolant in the coolant circuit 112 during start-up. In some implementations, the heat exchanger bypass valve 232 may facilitate controlling a coolant temperature by selectively bypassing a portion of the coolant through the bypass loop.

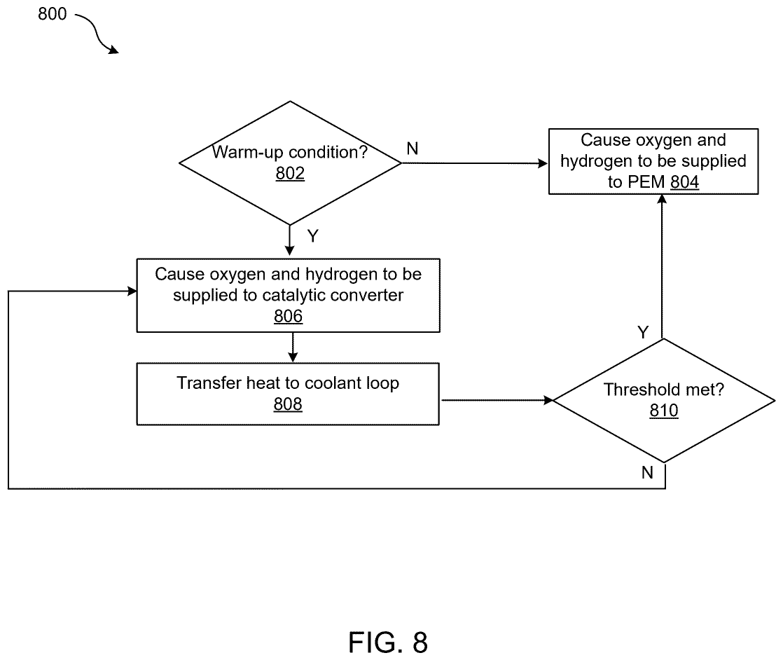

Referring now to FIG. 8, depicted is a flowchart showing an example method 800 of improving warm-up times of fuel cells, according to an example implementation of the present disclosure. The method 800 may be performed by, implemented on, or otherwise executed by the components, elements, or hardware described above with reference to FIG. 1 through FIG. 7. For example, the method 800 may be executed by the system 100 (e.g., by the fuel cell system 104, the control system 102, and/or compressor system 106) of FIG. 1. As a brief overview, at step 802, the system 100 may determine whether a warm-up condition is detected. At step 804, the system 100 may cause oxygen and/or hydrogen to be supplied to the PEM 204. At step 806, the system 100 may cause oxygen and/or hydrogen to be supplied to the catalytic converter 226. At step 808, the system 100 may transfer heat to the coolant circuit 112. At step 810, the system 100 may determine whether a threshold has been satisfied.

In greater detail, at step 802, the system 100 (e.g., the control system 102) may detect a warm-up or start-up condition of the fuel cell system 104. For example, the control system 102 may detect, determine, or otherwise identify a warm-up condition of the fuel cell system 104. In some embodiments, the control system 102 may identify the warm-up condition of the fuel cell system 104 based on data from a timer. For example, the control system 102 may measure a duration or time from a previous run-time of the fuel cell system 104. The control system 102 may identify the warm-up condition responsive to the measured duration satisfying a threshold (e.g., being greater than or equal to a duration corresponding to the warm-up condition). The threshold may be set based on the particular fuel cell system 104, an estimated time in which heat of the fuel cell system 104 naturally dissipates, etc. In some embodiments, the control system 102 may identify the warm-up condition of the fuel cell system 104 based on data from a sensor (e.g., sensor 124).

Where, at step 802, the system 100 determines there is no warm-up condition, the method 800 may continue to step 804 where the system 100 causes oxygen and/or hydrogen to be supplied to the PEM 204. For example, the control system 102, or another component of the system 100, may cause the flow control valve 236 depicted in FIG. 6C to cause pressurized hydrogen from the hydrogen source 200 and/or pressure regulator 202 to flow through the anode catalyst 206 of the PEM 204 and the control system 102 may cause the bypass valve 230 to cause a flow of pressurized oxygen to flow from the compressor 220 to the cathode catalyst 208. Together, the hydrogen supplied to the anode catalyst 206 and oxygen supplied to the cathode catalyst 208 may operate to produce electrical energy and heat for the fuel cell. More specifically, the hydrogen may be split into protons and electrons at the anode catalyst 206, and the oxygen may combine with the protons and electrons to produce electricity and water, with heat generated as a byproduct. The electrons may flow to an electrical power circuit 210 (e.g., a high-voltage bus) to generate electrical power, while the protons may move through the PEM 204 to facilitate the electrochemical reactions for producing the water and heat. In some implementations, excess hydrogen or oxygen may be fed through the catalytic converter 226, heat exchanger 228, and/or expander 224 to increase the efficiency of the system 100, as described herein.

Where, at step 802, the system 100 determines there is a warm-up condition, the method 800 may continue to step 806 where the system 100 causes oxygen and/or hydrogen to be supplied to the catalytic converter 226. For example, the control system 102, or another component of the system 100, may cause the flow control valve 236 depicted in FIG. 6C to cause pressurized hydrogen from the hydrogen source 200 and/or pressure regulator 202 to flow to the catalytic converter 226 and the control system 102 may cause the bypass valve 230 to cause a flow of pressurized oxygen from the compressor 220 to flow to the catalytic converter 226. The catalytic converter 226 may increase the temperature of the exhaust gases. The catalytic converter 226 and/or other portions of the system 100 (e.g., the compressor 220) may be powered by a battery source to facilitate increasing a temperature of the exhaust gases even when the PEM 204 is not at a maximum operating power.

At step 808, the system 100 may transfer heat to the coolant circuit 112. For example, the heat supplied by the catalytic converter 226 may be fed through the heat exchanger 228, which can supply heat to a coolant of the coolant circuit 112. Such configuration may facilitate quickly heating the coolant during, for example, the warm-up condition, thus reducing the amount of time it takes to warm the system 100 (e.g., the coolant circuit 112) to a desired temperature as compared to conventional techniques.

At step 810, the system 100 (e.g., the control system 102) may determine whether a threshold is satisfied. For example, the control system 102 may determine that a condition (e.g., temperature and/or pressure condition) satisfies a threshold criteria indicating termination of the warm-up condition (e.g., when the system 100 reaches an optimal operating temperature). In some implementations, the control system 102 may determine the temperature condition based on, for example, a reading from one or more of the sensors (e.g., sensor 124) of the coolant circuit 112 configured to measure a temperature of the coolant line.

Where, at step 810, the system 100 determines the threshold is satisfied, the method 800 may continue to step 804 where the fuel cell system 104 causes oxygen and/or hydrogen to be supplied to the PEM 204 as described herein. Where, at step 810, the system 100 determines the threshold is not satisfied, the method 800 may return to steps 806 and/or 808 to transfer heat to the coolant circuit 112 until the threshold criteria is met.

Such implementations improve warm-up times for the fuel cell system 104 by feeding pressurized oxygen and hydrogen through the catalytic converter 226 to increase exhaust temperature to be transferred to a coolant of the coolant circuit 112.

What is claimed is:

1. A vehicle, comprising:
a storage configured to store pressurized hydrogen;
a compressor configured to pressurize oxygen from air received at an intake of the compressor;
a fuel cell comprising an anode loop fluidically coupled to the storage and configured to receive the pressurized hydrogen therefrom and a cathode loop configured to receive the pressurized oxygen;
a catalytic converter arranged downstream from the anode loop, the catalytic converter configured to receive the pressurized hydrogen from the storage and receive at least one of recovered oxygen from the oxygen used by the cathode loop or pressurized oxygen from the compressor;
a first valve arranged downstream from the storage, the first valve configured to control a flow of the pressurized hydrogen from the storage to the anode loop or to the catalytic converter;
a second valve fluidically coupled to the compressor, the second valve configured to control a flow of the pressurized oxygen from the compressor to the cathode loop or to the catalytic converter; and
a processing circuit comprising one or more processors and memory, the memory storing instructions that, when executed, cause the processing circuit to:
detect a warm-up condition of the fuel cell; and
control the first and the second valve, to cause the pressurized oxygen and the pressurized hydrogen to be supplied to the catalytic converter, to cause the catalytic converter to produce heat to be transferred to a coolant loop of the fuel cell, during the warm-up condition.

2. The vehicle of claim 1, further comprising a heat exchanger arranged to transfer heat produced by the catalytic converter to the coolant loop of the fuel cell.

3. The vehicle of claim 1, wherein the processing circuit is further configured to:
determine that a temperature condition of the fuel cell satisfies a threshold criteria indicating termination of the warm-up condition; and
control the first valve and the second valve to cause the pressurized hydrogen to be supplied to the anode loop of the fuel cell, and to cause the pressurized oxygen to be supplied to the cathode loop, responsive to termination of the warm-up condition.

4. The vehicle of claim 3, wherein the temperature condition of the fuel cell is determined using a sensor arranged to measure a temperature of the coolant loop.

5. The vehicle of claim 3, wherein the first valve is configured to fluidically couple the storage to at least one of a first path to the anode loop or a second path to the catalytic converter, and wherein the second valve is configured to fluidically couple the compressor to at least one of a third path to the cathode loop or a fourth path to the catalytic converter.

6. The vehicle of claim 5, wherein, during the warm-up condition, the first valve fluidically couples the storage to the second path and the second valve fluidically couples the compressor to the fourth path.

7. The vehicle of claim 1, wherein the catalytic converter is battery powered.

8. The vehicle of claim 1, further comprising a battery electrically coupled to the compressor, to supply power to the compressor during the warm-up condition.

9. The vehicle of claim 1, further comprising a pressure regulator fluidically coupled between the storage and the anode loop of the fuel cell, the pressure regulator configured to regulate a pressure of the pressurized hydrogen for supplying to the anode loop or the catalytic converter.

10. An energy system for a vehicle, the energy system comprising:
a storage configured to store pressurized hydrogen;
a compressor configured to pressurize oxygen from air received at an intake of the compressor;
a fuel cell comprising an anode loop fluidically coupled to the storage and configured to receive the pressurized hydrogen therefrom and a cathode loop configured to receive the pressurized oxygen;
a catalytic converter arranged downstream from the anode loop, the catalytic converter configured to receive the pressurized hydrogen from the storage and receive at least one of recovered oxygen from the oxygen used by the cathode loop or pressurized oxygen from the compressor;
a first valve arranged downstream from the storage, the first valve configured to control a flow of the pressurized hydrogen from the storage to the anode loop or the catalytic converter;
a second valve fluidically coupled to the compressor, the second valve configured to control a flow of the pressurized oxygen from the compressor to the cathode loop or the catalytic converter; and
a processing circuit comprising one or more processors and memory, the memory storing instructions that, when executed, cause the processing circuit to:
detect a warm-up condition of the fuel cell; and
control the first and the second valve, to cause the pressurized oxygen and the pressurized hydrogen to be supplied to the catalytic converter, to cause the catalytic converter to produce heat to be transferred to a coolant loop of the fuel cell, during the warm-up condition.

11. The energy system of claim 10, further comprising a heat exchanger arranged to transfer heat produced by the catalytic converter to the coolant loop of the fuel cell.

12. The energy system of claim 10, wherein the processing circuit is further configured to:
determine that a temperature condition of the fuel cell satisfies a threshold criteria indicating termination of the warm-up condition; and
control the first valve and the second valve to cause the pressurized hydrogen to be supplied to the anode loop of the fuel cell, and to cause the pressurized oxygen to be supplied to the cathode loop, responsive to termination of the warm-up condition.

13. The energy system of claim 12, wherein the temperature condition of the fuel cell is determined using a sensor arranged to measure a temperature of the coolant loop.

14. The energy system of claim 12, wherein the first valve is configured to fluidically couple the storage to at least one of a first path to the anode loop or a second path to the catalytic converter, and wherein the second valve is configured to fluidically couple the compressor to at least one of a third path to the cathode loop or a fourth path to the catalytic converter.

15. The energy system of claim 14, wherein, during the warm-up condition, the first valve fluidically couples the storage to the second path and the second valve fluidically couples the compressor to the fourth path.

16. The energy system of claim 10, wherein the catalytic converter is battery powered.

17. The energy system of claim 10, further comprising a battery electrically coupled to the compressor, to supply power to the compressor during the warm-up condition.

18. A method comprising:
detecting, by one or more processors, a warm-up condition of a fuel cell, wherein the fuel cell comprises an anode loop and a cathode loop; and
controlling, by the one or more processors, a first valve and a second valve, to cause pressurized oxygen and pressurized hydrogen to be supplied to a catalytic converter arranged downstream from the fuel cell, to cause the catalytic converter to produce heat to be transferred to a coolant loop of the fuel cell, during the warm-up condition; wherein:
the first valve is configured to control a flow of the pressurized hydrogen from a hydrogen source to the anode loop or to the catalytic converter; and
the second valve is configured to control a flow of the pressurized oxygen from a compressor to the cathode loop or the catalytic converter.

19. The method of claim 18, further comprising supplying, via a battery electrically coupled to the compressor, electrical power to the compressor during the warm-up condition.

20. The method of claim 18, further comprising:
determining, by the one or more processors, that a temperature condition of the fuel cell satisfies a threshold criteria indicating termination of the warm-up condition; and
controlling, by the one or more processors, the first valve and the second valve to cause the pressurized hydrogen to be supplied to the anode loop of the fuel cell, and to cause the pressurized oxygen to be supplied to the cathode loop, responsive to termination of the warm-up condition.
